(19) United States
(12) Patent Application Publication
(10) Pub. No.: US 2008/0282914 A1
(43) Pub. Date: Nov. 20, 2008

(54) Fabric printing system, stencil kit, and method

(75) Inventors: Andrew Black, Fort Lauderdale, FL (US); Darin Bischof, Fort Lauderdale, FL (US)

Correspondence Address: LERNER GREENBERG STEMER LLP, P O BOX 2480, HOLLYWOOD, FL, 33022-2480, US

(73) Assignee: BLACKBOOKS STENCILS, Fort Lauderdale, FL (US)

(21) Appl. No.: 12/104,801

(22) Filed: Apr. 17, 2008

Related U.S. Application Data
(60) Provisional application No. 60/938,908, filed on May 18, 2007.

(51) Int. Cl. B41L 13/00

(52) U.S. Cl. 101/127

(57) ABSTRACT

A fabric-printing stencil system includes a first stencil plate with a continuous incision that defines a first stencil image dividing said first stencil plate into a positive image plate and a negative image plate. The negative and positive image plates are complementary to form the entire plate, except for the relatively narrow incision. The positive and negative image plates clamp a piece of fabric such that the positive image plate lies underneath and the fabric is stretched across the positive image plate, while the negative image plate lies above the fabric and covers the fabric, or vice versa. A second stencil plate has a second stencil image matched to the first stencil image and the first and second stencil images together define a completed image when printed on the fabric. The stencils are preferably cut by way of a laser from corresponding stencil plates and the images are printed by roller, brush, and spray application.

### CROSS-REFERENCE TO RELATED APPLICATION

This application claims the benefit, under 35 U.S.C. § 119(e) of our provisional patent application No. 60/938,908 filed May 21, 2007. The prior application is herewith incorporated by reference in its entirety.

### BACKGROUND OF THE INVENTION

### Field of the Invention

The invention relates to the art of fabric printing, in particular to T-shirt printing by way of stencils.

Various printing methods on fabric are known. These include stencil printing by way of spray, brush, or squeegee application. In simple strokes, a stencil with the shape to be imprinted—either the negative image or the positive image—is placed on the fabric and the paint is applied. The parts that are masked by the stencil are not printed, while the paint is applied to those parts of the underlying fabric that are exposed.

Fabric printing stencils are typically provided for single-layer print application and the corresponding image is a single-color image. If multi-color applications are desired, the fabric is printed by way of screen-printing or a similar process.

### BRIEF SUMMARY OF THE INVENTION

It is accordingly an object of the invention to provide a fabric printing system, a stencil kit, and a fabric printing method, which overcomes the above-mentioned disadvantages of the heretofore-known devices and methods of this general type and which allows intricate images to be printed by way of stencil printing and which further provides for a system and method that provides for a quick turn-around in print makeup for personalized imprint images and for a printing system with intricate imprint images produced by lay persons.

With the foregoing and other objects in view there is provided, in accordance with the invention, a fabric-printing stencil system, comprising:

a first stencil plate having a continuous incision formed therein defining a first stencil image and dividing the first stencil plate into a positive image plate and a negative image plate of the first stencil image, wherein the positive image plate and the negative image plate are complementary and configured to clamp therebetween a piece of fabric such that the positive image plate lies underneath and the fabric is stretched across the positive image plate, and the negative image plate lies above the fabric and covers the fabric, or vice versa; and

a second stencil plate having a second stencil image formed therein matched to the first stencil image formed in the first stencil plate, the first and second stencil images together defining a completed image when printed on the fabric.

In accordance with an added feature of the invention, the first and second stencil plates are two of a plurality of stencil plates formed with a variety of stencil images adapted to one another and defining a multi-layer artwork image after an image has been printed with the stencil plates.

In accordance with an added feature of the invention, the first stencil plate is made of a material having sufficient strength to clamp and stretch the fabric during application of the first stencil image.

In accordance with an added feature of the invention, the second stencil plate is made of a softer material than the first stencil plate, and the second stencil plate is configured for spray-painting the second stencil image onto the first stencil image.

In accordance with an added feature of the invention, the first and second stencil plates have equal outer dimensions and the first and second images are placed in the stencil plates to be in register when the stencil plates are placed congruently on top of one another.

With the above and other objects in view there is also provided, in accordance with the invention, a stencil production system, comprising:

a processor configured for inputting artwork and for generating therefrom a digitized file with stencils based on the artwork;

a cutting device connected to the processor and configured to cut stencils from plate material in accordance with the digitized file, the stencils including a first stencil with a positive stencil image and a negative stencil image together forming a complete stencil plate with the positive stencil image complementary to the negative stencil image, and at least one second stencil adapted to the first stencil and configured to print a second stencil image onto the first stencil image and to form a complete image.

In a preferred implementation of the invention, we also provide fabric printing kit, comprising:

a stencil system as described above;

a first supply of liquid paint and a paint applicator for printing the liquid paint onto a piece of fabric according to the positive and negative image plates;

a second supply of second paint for printing the second paint onto the piece of fabric according to the second image stencil.

In accordance with a preferred embodiment, the paint applicator is a paint roller and the second supply of paint is a spray paint can.

With the above and other objects in view there is also provided, a stencil-production and fabric printing method, which comprises:

inputting artwork into a processor and generating a digital file on the basis of the artwork;

communicating the digital file to a stencil cutting device and operating the stencil cutting device to cut a first stencil and a second stencil from at least one plate of stencil material, the first stencil including a positive stencil image and a negative stencil image complementary to one another and together forming a substantially complete first stencil plate;

clamping a piece of fabric in the first stencil plate by placing the positive stencil image on the fabric while covering the fabric with the negative stencil image, or vice versa, and painting the exposed surface of the fabric not covered by the positive or negative stencil image, and forming an imprint of the first stencil image; and

placing the second stencil onto the fabric, in alignment with the first stencil image, and printing a second image according to the second stencil onto the fabric.

The term fabric as used herein is to be understood in its broadest sense and the invention applies to a multitude of possible substrates. In a preferred embodiment, the invention is used to imprint T-shirts, a sweatshirts, towels, or the like.

As noted above, the system is capable of expansion to more than two stencils wherein each of a plurality of stencils may be configured to print a different color paint onto the fabric. This forms a multi-color image in accordance with the stencils.

In sum, there is provided a fabric-printing stencil system that includes a first stencil plate with a continuous incision that defines a first stencil image dividing the first stencil plate into a positive image plate and a negative image plate. The negative and positive image plates are complementary to form the entire plate, except for the relatively narrow incision. The positive and negative image plates clamp a piece of fabric such that the positive image plate lies underneath and the fabric is stretched across the positive image plate, while the negative image plate lies above the fabric and covers the fabric, or vice versa. A second stencil plate has a second stencil image matched to the first stencil image and the first and second stencil images together define a completed image when printed on the fabric. The stencils are preferably cut by way of a laser from corresponding stencil plates and the images are printed by roller, brush, and spray application.

Other features which are considered as characteristic for the invention are set forth in the appended claims.

Although the invention is illustrated and described herein as embodied in a fabric printing system, a stencil kit, and a fabric printing method, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE DRAWING

FIG. 1 is an overview of a production system for a set of stencils according to the invention;

FIG. 2 is a plan view onto a first stencil plate with a base stencil;

FIG. 3 is a plan view onto a second stencil plate with an overlay stencil;

FIG. 4 is a section taken along the line IV-IV through the first stencil plate, with a piece of fabric clamped therein;

FIG. 5 is a side view of the second stencil plate placed on the fabric during a spray-paint application;

FIG. 6 shows a base stencil of a further exemplary artwork illustration;

FIG. 7 is a corresponding base print;

FIG. 8 shows a second-layer stencil of the further illustration;

FIG. 9 is a corresponding second-layer print;

FIG. 10 shows a third-layer stencil of the further illustration;

FIG. 11 is a corresponding third-layer print; and

FIG. 12 shows the print resulting from the stencils of FIGS. 6, 8, and 10.

### DESCRIPTION OF THE PREFERRED EMBODIMENTS

Referring now to the figures of the drawing in detail and first, particularly, to FIG. 1 thereof, there is seen a computer 1 which forms the input stage for the production system according to the invention. Artwork 2 is either input into or created at the computer 1. There, the artwork image is digitized and processed, typically in pixilated form as a two-dimensional bitmap image and/or in vector form. The processed image is then spooled through a printer driver and sent through a print server 3 to a laser 4 with cutting and engraving capabilities. The laser 4 then cuts the shapes dictated by the artwork image received from the computer 1 from a plate material 5.

The laser 4 used in the exemplary embodiment is an SS660 (Superspeed 660) multibeam laser available from Universal Laser Systems, Scottsdale, Ariz. The SS660 is a 60 W laser with two laser beams that can be focused into a dual beam or a single beam. The best resolution to be obtained with the laser is 1000 lines per inch, which also translates to approximately 1000 dpi. The maximum dimensions for the plate material to be cut in the SS660 are 32 inches by 18 inches. The thickness and material of the plate may vary from acrylic plate, to wood, to cardboard, and many other materials.

Various software programs are available for processing the artwork, for example, Corel Draw®, AutoCAD®, Illustrator® to name a few. The computer 1 connects to the print server 3 via a parallel connection and the print server 3 connects to the laser 4 via a USB connection. It will be understood by those skilled in the art that various other connections are possible as well. Also, the artwork may be prepared at a remote makeup location and then transferred to the computer 2, in which the laser driver is installed.

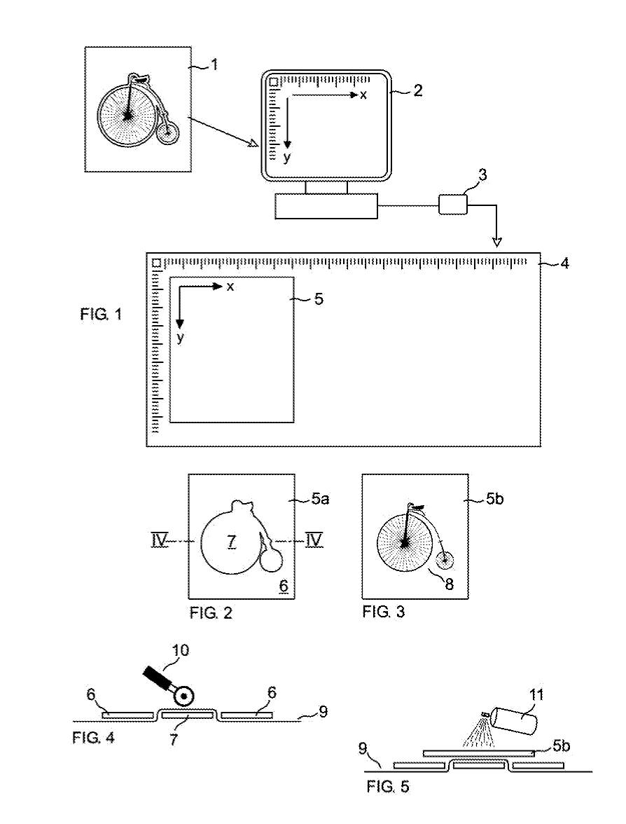

Referring now to FIG. 2, there is shown a plate 5a forming a base stencil with a first stencil image. The first stencil image is defined by a positive image plate 6 and a negative image plate 7. The positive and negative image plates were cut from a single plate 5a in the laser 4 along a continuous incision. The spacing between the positive and negative image plates 6 and 7 is defined by the focusing width of the laser beam (or beams) and it is typically in the range of a few mil, or 1/32 inches or less.

FIG. 3 shows a further plate 5b forming an overlay stencil with a negative image 8 that corresponds to the positive and negative images 6 and 7. As will be described in the following, the base stencil forms the areal paint underlay, while the overlay stencil 8 forms a spray-painting stencil. The plates 5a and 5b may be formed of the same or of different material. In a preferred embodiment, the plate 5a with the positive and negative images 6 and 7 is formed of a relatively stiff material such as pressboard or acrylic. The stiffness is important because the plate 5a is also used as a fabric stretch frame. The plate 5b may be formed of a thinner and less stiff material, because the purpose of the plate 5b is only as a printing stencil.

The stencils are used as will be described in the following with reference to FIGS. 4 and 5: A piece of fabric 9, such as a T-shirt or a towel or the like, is clamped into the first stencil plate 5a, with the positive image plate 6 covering the fabric and the negative image plate 7 underneath the fabric. This placement stretches the fabric across the negative image plate 7 and covers the remaining areas with the positive image plate 6 portions of the plate 5a. It will be understood, of course, that the two stencils are also reversible, with the image plate 7 being on top and the image plate 6 underneath the fabric. In that case, the “negative” and “positive” descriptors of the images, of course, would have to be reversed.

After the fabric has been properly clamped and smoothed, as shown in FIG. 4, the exposed portion is painted with a paint roller 10. It will be understood that various other printing and painting techniques are possible as well. Here, however, the image is composed of a flat, monochrome, solid base image (corresponding to the tree outline shown in FIG. 2), so that paint rolling is advantageous. As noted above, the two image plates 6 and 7 may also be reversed. In that case, the roller may be used to feather the image outwardly from the center, with the image plate 7 covering the image and avoiding paint application in the center.

After the rolled-on paint of the underlay image has dried, the second part of the image is applied. With reference to FIG. 5, the second plate 5b with the image 8 is placed onto the image 7 and the overlay is spray-painted onto the underlay from a spray paint can 11. Again, various other printing techniques are available for this purpose, including, but not limited to, squeegee, brush, or screen-print applications.

The method according to the invention may be summarized as follows: First, the artwork is acquired into the computer 2. The artwork will typically be provided by the customer either in the form of a print or as a file in digital format. The computer operator (or a corresponding software program) then converts the artwork into the digitized representations 6/7 and 8. In the example illustrated herein, the image 7 will be defined as a vector file and image 8 may be a bitmap or a vector file.

After confirmation by the customer—the customer may view the layout files on the computer screen or from a black-and-white printout on paper—the files are sent to the laser 4 for cutting of the board. The two boards 5a and 5b with the image 7 and the image 8, respectively, may be cut in a single run or they may be cut separately from one another. If, for example, the two plates 5a and 5b are formed of a different material, it is advantageous to cut them at different times.

After cutting in the laser and removal from the laser cutting table, the stencils are packaged into an end-user kit. Such a kit may comprise, inter alia, the two stencil plates 5a and 5b, a can with fabric paint, a paint roller or brush, a can of spray paint, a sample of shirts, and instructions. Various other kits, of course, may be packaged as well.

It will be understood that the two-stencil layout described above is only exemplary. The layout may be expanded into further multi-stencil layouts, with a resulting multi-color or even full-color image printable by the end user. Proper register of the individual stencils is easily ensured by cutting the plates 5a, 5b, etc. so that the images properly overlap when the edges of the plates are properly aligned. It is also possible to add reference keys or the like that assure proper alignment and register.

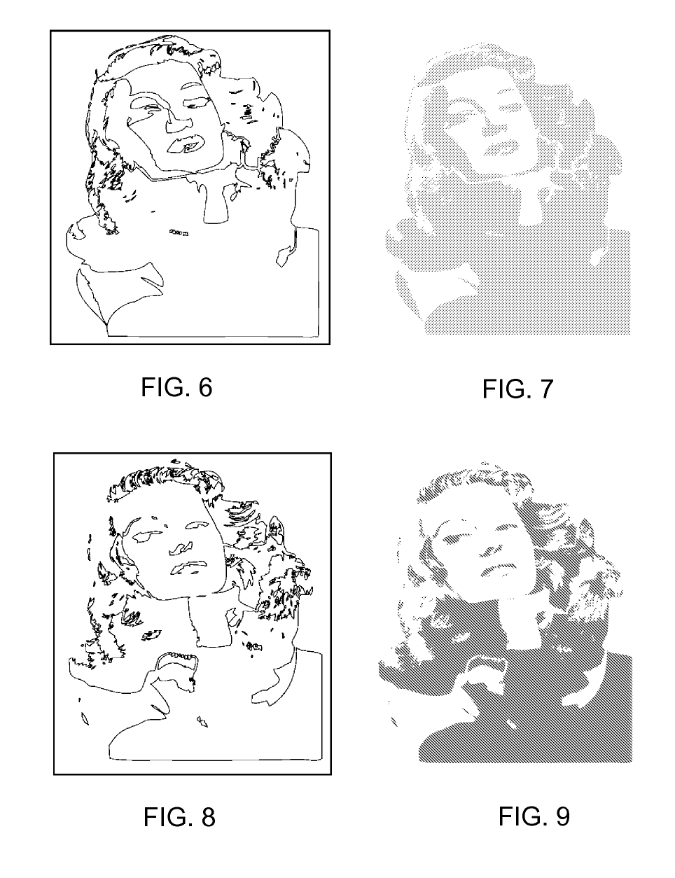

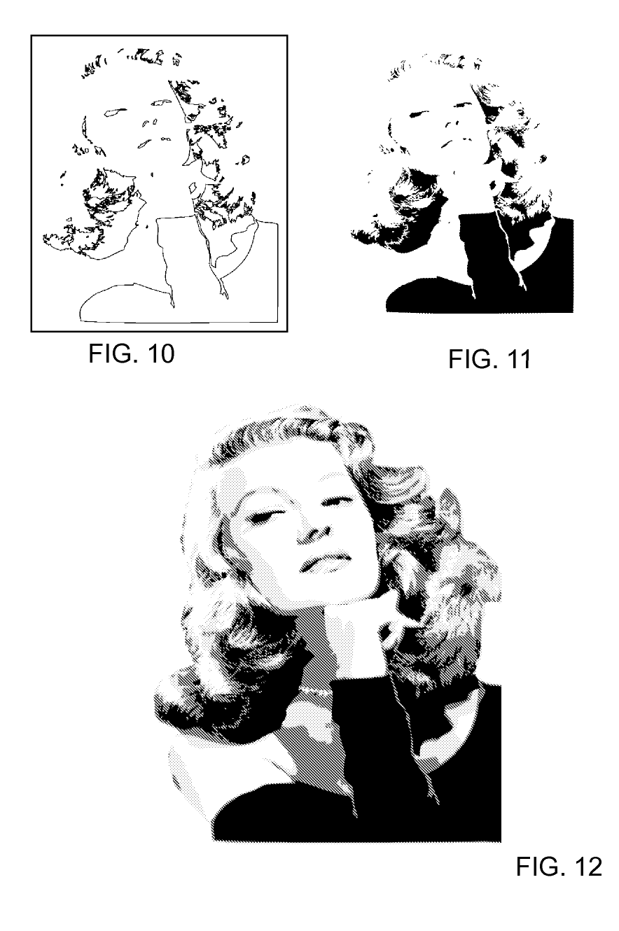

FIGS. 6-12 pertain to a further exemplary embodiment of the invention. There, a plurality of increasingly detailed stencils are shown in FIGS. 6, 8, and 10. The resulting three-tone image represents Rita Hayworth. FIG. 7 represents the base image, printed from the stencil of FIG. 6 in the lightest tone (here, grey). FIG. 9 is printed from the stencil of FIG. 8, in a slightly darker tone. FIG. 11 is printed from the stencil of FIG. 10, in the darkest tone. The three images are over-laid in FIG. 12. It will be understood that the same image may also be printed in negative, with FIG. 7 being the darkest and FIG. 11 being the lightest.

The stencil system of FIGS. 6-11 may be augmented by providing a base stencil with the basic outline (i.e., the base stencil would precede the stencil of FIG. 6). Such a stencil can be easily cut by simply following the outermost lines of the image and cutting across the various material bridges that interrupt the outline.

1. A fabric-printing stencil system, comprising:
a first stencil plate having a continuous incision formed therein defining a first stencil image and dividing said first stencil plate into a positive image plate and a negative image plate of said first stencil image, wherein said positive image plate and said negative image plate are complementary and configured to clamp therebetween a piece of fabric such that said positive image plate lies underneath and said fabric is stretched across said positive image plate, and said negative image plate lies above said fabric and covers said fabric, or vice versa; and
a second stencil plate having a second stencil image formed therein matched to said first stencil image formed in said first stencil plate, said first and second stencil images together defining a completed image when printed on said fabric.

2. The fabric-printing stencil system according to claim 1, wherein said first and second stencil plates are two of a plurality of stencil plates formed with a variety of stencil images adapted to one another and defining a multi-layer artwork image after an image has been printed with said stencil plates.

3. The fabric-printing stencil system according to claim 1, wherein said first stencil plate is made of a material having sufficient strength to clamp and stretch the fabric during application of the first stencil image.

4. The fabric-printing stencil system according to claim 3, wherein said second stencil plate is made of a softer material than said first stencil plate, and said second stencil plate is configured for spray-painting the second stencil image onto the first stencil image.

5. The fabric-printing stencil system according to claim 1, wherein said first and second stencil plates have equal outer dimensions and said first and second images are placed in said stencil plates to be in register when said stencil plates are placed congruently on top of one another.

6. A stencil production system, comprising:
a processor configured for inputting artwork and for generating therefrom a digitized file with stencils based on the artwork;
a cutting device connected to said processor and configured to cut stencils from plate material in accordance with the digitized file, the stencils including a first stencil with a positive stencil image and a negative stencil image together forming a complete stencil plate with the positive stencil image complementary to the negative stencil image, and at least one second stencil adapted to said first stencil and configured to print a second stencil image onto the first stencil image and to form a complete image.

7. The stencil production system according to claim 6, wherein said cutting device is a laser cutting device.

8. A fabric printing kit, comprising:
a stencil system according to claim 1;
a first supply of liquid paint and a paint applicator for printing the liquid paint onto a piece of fabric according to the positive and negative image plates;
a second supply of second paint for printing the second paint onto the piece of fabric according to the second image stencil.

9. The fabric printing kit according to claim 8, wherein said paint applicator is a paint roller and said second supply of second paint is a spray paint can.

10. A stencil-production and fabric printing method, which comprises:
inputting artwork into a processor and generating a digital file on the basis of the artwork;
communicating the digital file to a stencil cutting device and operating the stencil cutting device to cut a first stencil and a second stencil from at least one plate of stencil material, the first stencil including a positive stencil image and a negative stencil image complementary to one another and together forming a substantially complete first stencil plate;
clamping a piece of fabric in the first stencil plate by placing the positive stencil image on the fabric while covering the fabric with the negative stencil image, or vice versa, and painting the exposed surface of the fabric not covered by the positive or negative stencil image, and forming an imprint of the first stencil image; and
placing the second stencil onto the fabric, in alignment with the first stencil image, and printing a second image according to the second stencil onto the fabric.

11. The method according to claim 10, wherein the piece of fabric is a T-shirt, a sweatshirt, or a towel.

12. The method according to claim 10, wherein the first and second stencil are two of a plurality of stencils each configured to print a different color paint onto the fabric to form a multi-color image in accordance with the stencils.
